(19) United States
(12) Patent Application Publication
(10) Pub. No.: US 2025/0353491 A1
(43) Pub. Date: Nov. 20, 2025

(54) METHOD FOR CONTROLLING A SUBJECT VEHICLE AND VEHICLE CONTROL SYSTEM FOR A SUBJECT VEHICLE

(71) Applicant: DENSO CORPORATION, Kariya-city (JP)

(72) Inventors: ARISTEIDIS KOPANAKIS, Eching (DE); SOTA IWASE, Kariya-city (JP)

(21) Appl. No.: 19/205,289

(22) Filed: May 12, 2025

(30) Foreign Application Priority Data
May 15, 2024 (DE) 102024113598.0

(51) Int. Cl. B60W 30/09; B60W 30/095; B60W 30/14; B60W 30/18

(52) U.S. Cl. CPC B60W 30/09; B60W 30/0956; B60W 30/146; B60W 30/18163; B60W 2520/10; B60W 2530/201; B60W 2552/53; B60W 2554/4042; B60W 2554/802; B60W 2556/35

(57) ABSTRACT

A method and a system are configured to: determine the driving situations of the subject vehicle, of oncoming traffic in front of the subject vehicle and of the rear vehicle in view of overtaking the subject vehicle by the rear vehicle; and control the subject vehicle based on the determined driving situations of the subject vehicle, of the oncoming traffic and of the rear vehicle, such that in the case that it is determined that the current driving situations of the subject vehicle, of the oncoming traffic and of the rear vehicle do not allow a timely overtaking manoeuvre of the subject vehicle by the rear vehicle, the vehicle speed of the subject vehicle is reduced and/or the driving direction of the subject vehicle is changed for allowing the rear vehicle to overtake the subject vehicle.

### CROSS REFERENCE TO RELATED APPLICATION

The present application claims the benefit of priority from German Patent Application No. 102024113598.0 filed on May 15, 2024. The entire disclosure of the above application is incorporated herein by reference.

### TECHNICAL FIELD

The present disclosure relates to a method for controlling a subject vehicle when the subject vehicle being overtaken by a rear vehicle and a vehicle control system for a subject vehicle traveling in a driving lane.

### BACKGROUND

The apparatus and method according to a related art discloses an exact recognition of rear vehicle which move in front of a subject vehicle with a short distance during traffic jams, for example, in relation to vehicle speeds of or below 30 km/h. The aim is to identify these kinds of rear vehicles. Another related art discloses an apparatus and a method for deciding a maneuver of a surrounding or nearby vehicle, by which a maneuver of the surrounding or nearby vehicle may be accurately decided. The present disclosure allows to fuse first surrounding vehicle information and second surrounding vehicle information when the surrounding vehicle detected by a front radar device and the surrounding vehicle detected by a corner radar device are the same. Another related art discloses a method and a device for estimating a movement of a rear vehicle in front of a subject vehicle only in which in general it is referred to camera data, radar data and sensor data in relation to a behavior of a vehicle. Another related art discloses a corner radar to detect information about a surrounding vehicle and calculates movement and determines a cut-in intention of the surrounding vehicle due to rotational motion.

### SUMMARY

A method for controlling a subject vehicle when being overtaken by a rear vehicle, includes: determining driving situations of the subject vehicle, of oncoming traffic in front of the subject vehicle, and of the rear vehicle, in view of overtaking the subject vehicle by the rear vehicle; and controlling the subject vehicle based on the determined driving situations of the subject vehicle, of the oncoming traffic, and of the rear vehicle, such that in response to determining that the driving situations of the subject vehicle, of the oncoming traffic, and of the rear vehicle, which are currently determined, do not allow a timely overtaking manoeuvre of the subject vehicle by the rear vehicle, a vehicle speed of the subject vehicle is reduced and/or a driving direction of the subject vehicle is changed for allowing the rear vehicle to overtake the subject vehicle.

### BRIEF DESCRIPTION OF DRAWINGS

With reference to the accompanied drawings and corresponding details of the description, the foregoing object of the present disclosure are described more in detail together with other objects, features and advantages.

FIG. 1 shows a driving situation for which the safety is to be increased by the present disclosure.

FIG. 2 shows a related art in which due to an overtaking action of a rear vehicle a crash occurs with the subject vehicle in view of an oncoming vehicle according to the related art.

FIG. 3 shows an application of the method and control system of the present disclosure so that due to an overtaking action of a rear vehicle a crash does not occur with the subject vehicle even in view of an oncoming vehicle.

FIG. 4 shows amounts determined by the subject vehicle according to the present disclosure for increasing safety during overtaking.

### DETAILED DESCRIPTION

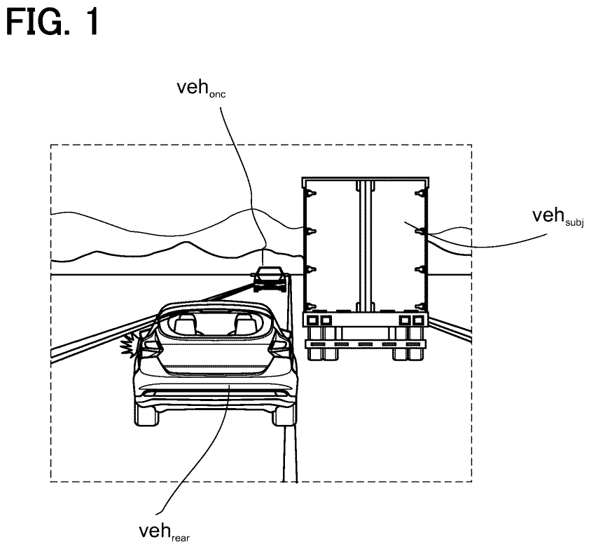

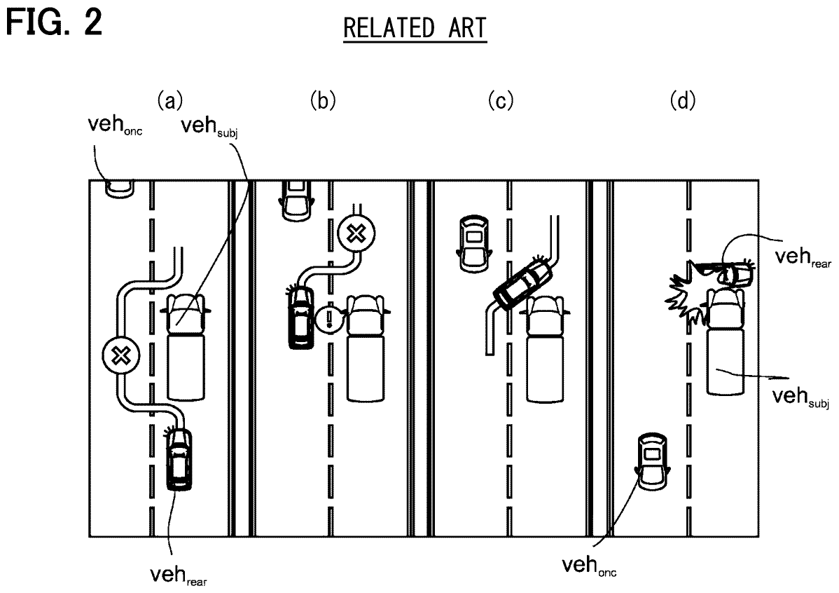

In a driving situation as shown in FIG. 1, a rear vehicle vehᵣₑₐᵣ overtakes a subject vehicle veh_{subj} while an oncoming vehicle veh_{onc} is approaching. In this situation an accident might occur in the case that there is not enough space for the rear vehicle vehᵣₑₐᵣ to complete its overtaking manoeuvre in front of the subject vehicle veh_{subj}. This is shown in (a) to (d) of FIG. 2 more in detail. In (a) of FIG. 2, the rear vehicle vehᵣₑₐᵣ starts to overtake the subject vehicle veh_{subj}. In (b) of FIG. 2, it is already visible that with all three vehicles moving there is only a small space left for the rear vehicle vehᵣₑₐᵣ to move in in front of the subject vehicle veh_{subj}. As can be gathered from (c) of FIG. 2, the distance between the approaching rear vehicle vehᵣₑₐᵣ and the subject vehicle veh_{subj} is very small which leads in (d) of FIG. 2 to a crash between the rear vehicle vehᵣₑₐᵣ and the subject vehicle veh_{subj} while the oncoming vehicle veh_{onc} continues its route without being involved by the crash itself.

According to a first aspect of the present disclosure, a method for controlling a subject vehicle when being overtaken by a rear vehicle is provided, and the method includes the steps of determining the driving situations of the subject vehicle, of oncoming traffic in front of the subject vehicle and of the rear vehicle in view of overtaking the subject vehicle by the rear vehicle, controlling the subject vehicle based on the determined driving situations of the subject vehicle, of the oncoming traffic and of the rear vehicle, so that in the case that it is determined that the current driving situations of the subject vehicle, of the oncoming traffic and of the rear vehicle do not allow a timely overtaking manoeuvre of the subject vehicle by the rear vehicle, the vehicle speed of the subject vehicle is reduced and/or the driving direction of the subject vehicle is changed for allowing the rear vehicle to overtake the subject vehicle. The benefit is that based on a reaction of the subject vehicle alone, a collision with the rear vehicle can be avoided.

With the above method, safety driving of the subject vehicle is able to be increased. This may be done by relying only on data obtained by the subject vehicle.

According to a second aspect of the present disclosure, in the method according to the first aspect, determining the driving situation of the subject vehicle includes determining the driving speed v_{subj} of the subject vehicle and/or the position of the subject vehicle in a traffic lane in which the subject vehicle is driving. With such a determination, due to control steps which can be easily implemented, a collision can be avoided.

According to a third aspect of the present disclosure, in the method according to the first or second aspect, the step of determining the driving situations of the subject vehicle, of oncoming traffic in front of the subject vehicle and of the rear vehicle includes determining the vehicle speed v1 of the rear vehicle, the distance D1 between the rear vehicle and the subject vehicle, the vehicle speed v2 of the oncoming vehicle and the distance D2 between an oncoming vehicle of the oncoming traffic and the subject vehicle, determining the time to collision TTC1 between the oncoming vehicle and the rear vehicle based on the vehicle speed v1, the distance D1, the vehicle speed v2 and the distance D2, determining the driving distance D of the subject vehicle until the collision point between the oncoming vehicle and the rear vehicle based on the time to collision TTC1 between the oncoming vehicle and the rear vehicle, the vehicle speed v1 of the rear vehicle and the vehicle speed v2 of the oncoming vehicle, determining the time to collision TTC2 of the subject vehicle until the collision point between the oncoming vehicle and the rear vehicle based on the driving distance D of the subject vehicle and the vehicle speed v_{subj} of the subject vehicle. This enables the subject vehicle to calculate the necessary information based on its own sensors without necessarily requiring communicating with other traffic participants which increases the reaction speed of the subject vehicle.

According to a fourth aspect of the present disclosure, in the method according to the third aspect, the step of controlling the subject vehicle based on the determined driving situations of the subject vehicle, of the oncoming traffic and of the rear vehicle includes controlling the subject vehicle so that a) in the case that the distance D1 between the rear vehicle and the subject vehicle is 0 or smaller than 0 and the time to collision TTC2 of the subject vehicle is smaller than a first threshold value α, the vehicle speed v_{subj} of the subject vehicle is reduced, and/or b) in the case that the distance D1 between the rear vehicle and the subject vehicle is 0 or smaller than 0 and the time to collision TTC2 of the subject vehicle is smaller than a second threshold value β and the distance W of the subject vehicle from the side of the lane is at least a third threshold γ, the vehicle speed v_{subj} of the subject vehicle is reduced and the subject vehicle is steered towards the side of the lane. Therefore, it is possible to react appropriately on different traffic condition while guaranteeing a safe reaction of the subject vehicle.

According to a fifth aspect of the present disclosure, in the method according to the fourth aspect, in the step of controlling the subject vehicle based on the determined driving situations of the subject vehicle, of the oncoming traffic and of the rear vehicle the length L of the subject vehicle is considered. This enables a safe calculation in the subject vehicle based on the sensor positions in the subject vehicle.

According to a sixth aspect of the present disclosure, a vehicle control system for a subject vehicle in a driving lane is provided. The vehicle control system includes: rear sensing means configured to sense the distance D1 between the subject vehicle and a rear vehicle traveling behind relative to the subject vehicle and a speed v1 of the rear vehicle, forward sensing means configured to sense the distance D2 between the subject vehicle and an oncoming vehicle in a neighbouring lane to the driving lane of the subject vehicle and a speed v2 of the oncoming vehicle, lane sensing means configured to sense the lateral localization of the subject vehicle in the driving lane, processing means configured to process the distance and speed sensed by the rear sensing means, the distance and speed sensed by the forward sensing means and the lateral localization sensed by the lane sensing means for generating output signals for at least one of reducing the speed v_{subj} of the subject vehicle and steering the subject vehicle to the side of the driving lane of the subject vehicle in order to allow the rear vehicle to pass the subject vehicle while avoiding a collision between the subject vehicle and the rear vehicle. The benefit of such a vehicle control system is that based on a reaction of the subject vehicle alone, a collision with the rear vehicle can be avoided.

According to a seventh aspect of the present disclosure, in the vehicle control system according to the sixth aspect, the processing means is configured to determine the time to collision TTC1 between the oncoming vehicle and the rear vehicle based on the vehicle speed v1, the distance D1, the vehicle speed v2 and the distance D2, determine the driving distance D of the subject vehicle until the collision point between the oncoming vehicle and the rear vehicle based on the time to collision TTC1 between the oncoming vehicle and the rear vehicle, the vehicle speed v1 of the rear vehicle and the vehicle speed v2 of the oncoming vehicle, determine the time to collision TTC2 of the subject vehicle until the collision point between the oncoming vehicle and the rear vehicle based on the driving distance D of the subject vehicle and the vehicle speed v_{subj} of the subject vehicle. This enables the control system subject vehicle to calculate the necessary information based on its own sensors without necessarily requiring communicating with other traffic participants which increases the reaction speed of the subject vehicle.

According to an eighth aspect of the present disclosure, in the vehicle control system according to the seventh aspect, the processing means is configured to generate the output signals so that a) in the case that the distance D1 between the rear vehicle and the subject vehicle is 0 or smaller than 0 and the time to collision TTC2 of the subject vehicle is smaller than a first threshold value α, the vehicle speed v_{subj} of the subject vehicle is reduced, and/or b) in the case that the distance D1 between the rear vehicle and the subject vehicle is 0 or smaller than 0 and the time to collision TTC2 of the subject vehicle is smaller than a second threshold value β and the distance W of the subject vehicle from the side of the lane is at least a third threshold γ, the vehicle speed v_{subj} of the subject vehicle is reduced and the subject vehicle is steered towards the side of the lane. Therefore, it is possible for the vehicle control system according to the present disclosure to react appropriately on different traffic condition while guaranteeing a safe reaction of the subject vehicle.

According to a ninth aspect of the present disclosure, in the vehicle control system according to one of the sixth through eighth aspects, the processing means is configured to consider the length L of the subject vehicle. This enables a safe calculation by the vehicle control system in the subject vehicle based on the sensor positions in the subject vehicle.

In the present disclosure, the processing means may be provided by at least one of (i) a circuit and (ii) a processor, which executes a computer program stored in a memory.

The term “processor” may refer to a single hardware processor or several hardware processors that are configured to execute processing defined by computer program code (i.e., one or more instructions of a computer program) by sequentially reading the computer program code included in a computer program. In other words, a “processor” is a hardware device that executes one or more program processes. Therefore, the computer program code can be considered software that defines the processing of the processor according to its content. The “processor” may be a general-purpose or specific-purpose processor, such as, CPU (Central Processing Unit), a microprocessor, GPU (Graphics Processing Unit) and DFP (Data Flow Processor), but is not limited to these examples.

The term “memory” is a non-transitory tangible storage medium and may refer to a single or several hardware memories configured to store computer program code and/or data in a manner accessible by the processor. The “memory” may be implemented using any suitable memory technology, such as SRAM (Static Random-access Memory), SDRAM (Synchronous Dynamic RAM), nonvolatile/flash memory, or other types of memory. The computer program code that constitutes the program is stored on the memory and, when executed by a processor, causes the processor to realize the various functions described above.

The term “circuit” refers to a single hardware logic circuit or several hardware logic circuits (in other words, “circuitry”) that are configured to execute specific processing defined based on a pre-designed circuit configuration. In other words (and in contrast to the “processor”), the term “circuit” in the present disclosure refers to a hardware device that executes specific processing based on a circuit configuration, not processing defined by software such as the above-described computer program code. For instance, “circuit” may include a custom IC (Integrated Circuit) such as ASIC (Application Specific Integrated Circuit) or FPGA (Field Programmable Gate Array) designed using a hardware description language (HDL). That is, the term “circuit” in the present disclosure includes all hardware circuits except the above-described processor that executes processing by reading computer program code.

In the present disclosure, the phrase “at least one of (i) a circuit and (ii) a processor” should be interpreted disjunctively (logical OR) and should not be interpreted as at least one circuit and at least one processor. Thus, only the circuit may cause the vehicle control system to execute all the functions, only the processor may cause the vehicle control system to execute all the functions, or the circuit may cause the vehicle control system to execute some of the functions and the processor may cause the vehicle control system to execute the remaining functions. In the last case, for instance, if the vehicle control system executes functions A to C, functions A and B may be implemented by the circuit, and the remaining function C may be implemented by the processor.

The present disclosure is related to a method and a control system for anticipating and avoiding an accident during a “short overtake and cut-in” scenario. It is applicable to single carriageways with one lane for each direction and a speed limit of 100 km/h.

The subject vehicle is equipped with ADAS (Advanced driver-assistance system) sensors for forward sensing of speed and distance, rear corner sensing of speed and distance and forward or side sensing for lateral localization within the lane. ADAS sensors are a group of automotive sensors used in advanced driver assistance systems. These sensors help keep drivers safe by providing information about the car's surroundings. There are many different types of ADAS sensors, including cameras, radar, lidar, sonar/ultrasonic, and more. The ADAS sensors correspond to the rear sensing means, forward sensing means, and lane sensing means. Combining the data from these sensors is helpful to judge if the overtaking vehicle will perform a potentially dangerous short cut-in manoeuvre by a rear vehicle. Even though the “right of way” is not with the rear vehicle, which is overtaking, allowing sufficient space for it to complete its manoeuvre, the method and control system of the present disclosure can avoid a serious accident between the subject vehicle and the rear vehicle, especially in a situation if an oncoming vehicle approaches on the neighboring lane to the subject vehicle.

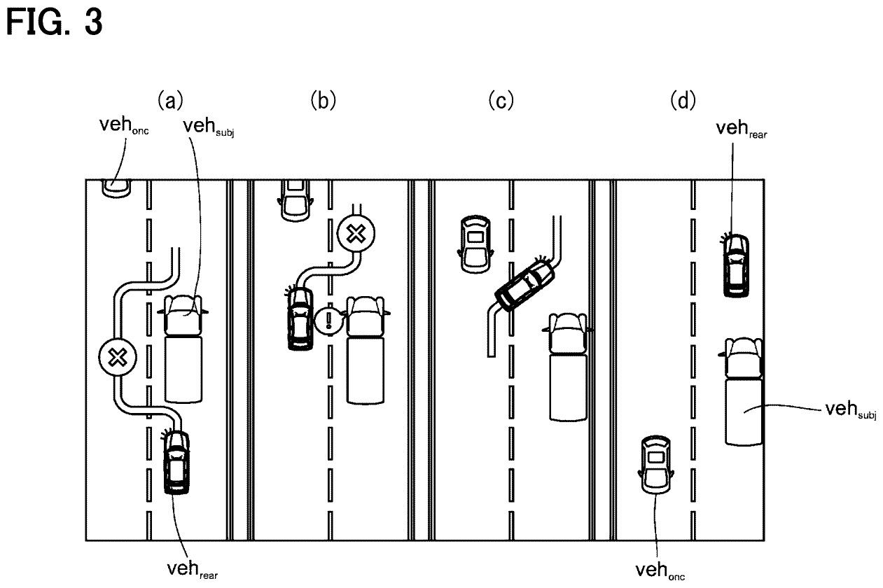

The successful implementation of the present disclosure is shown in (a) to (d) of FIG. 3. In (a) of FIG. 3, the rear vehicle vehᵣₑₐᵣ starts to overtake the subject vehicle veh_{subj}. In (b) of FIG. 3, it is already visible that with all three vehicles moving there is a small space left for the rear vehicle vehᵣₑₐᵣ to move in in front of the subject vehicle veh_{subj}. As can be gathered from (c) of FIG. 3, the distance between the approaching rear vehicle vehᵣₑₐᵣ and the subject vehicle veh_{subj} is larger than in (c) of FIG. 2 since the subject vehicle veh_{subj} has reduced its speed and has moved to the right side of its lane. This action of the subject vehicle veh_{subj} has avoided a crash between the rear vehicle vehᵣₑₐᵣ and the subject vehicle veh_{subj}. As already depicted in (d) of FIG. 2, also in (d) of FIG. 3, the oncoming vehicle veh_{onc} continues its route without being involved by an interaction between the subject vehicle veh_{subj} and the rear vehicle vehᵣₑₐᵣ.

While in (a) to (d) of FIG. 3 for the oncoming vehicle veh_{onc} and the rear vehicle vehᵣₑₐᵣ cars are shown while for the subject vehicle veh_{subj} a truck is shown. The present disclosure is not restricted to this but is applicable to any traffic participant linearly movable in a lane of a carriageway for the oncoming vehicle veh_{onc}, the rear vehicle vehᵣₑₐᵣ and the subject vehicle veh_{subj}, like bicycles, motorcycles, trucks, busses.

The method for controlling the subject vehicle in order to implement the successful avoidance of an accident as shown in (a) to (d) of FIG. 3 includes two steps.

In a first step the driving situations of the subject vehicle, of oncoming traffic in front of the subject vehicle and of the rear vehicle in view of overtaking the subject vehicle by the rear vehicle are determined.

In a second step the subject vehicle is controlled based on the determined driving situations of the subject vehicle, of the oncoming traffic and of the rear vehicle in order to allow the rear vehicle to overtake the subject vehicle. This control might include in the case that it is determined that the current driving situations of the subject vehicle, of the oncoming traffic and of the rear vehicle do not allow a timely overtaking manoeuvre of the subject vehicle by the rear vehicle, that the vehicle speed of the subject vehicle is reduced and/or that the driving direction of the subject vehicle is changed, to the side of the lane away from the oncoming traffic. The process in the second step may be implemented by a processor, such as CPU, by executing a program stored in a non-transitory storage medium.

The implementation of the above method and a vehicle control system for a subject vehicle for implementing this method are described more in detail.

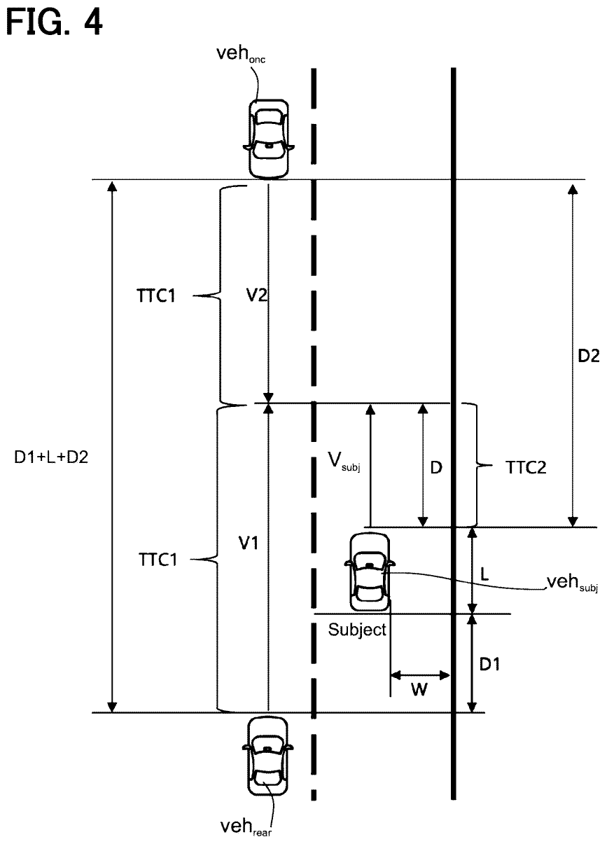

FIG. 4 shows amounts determined by the subject vehicle according to the present disclosure for increasing safety during overtaking. The subject vehicle may use its ADAS sensors as follows.

The ADAS sensors of the subject vehicle for forward sensing for distance and speed are used to sense the speed v2 of the oncoming vehicle veh_{onc} and the distance D2 between the oncoming vehicle veh_{onc} and the subject vehicle veh_{subj} as characterizing the driving situation of the oncoming vehicle veh_{onc}. For this forward sensing, radar and lidar are for instance usable.

The ADAS sensors of the subject vehicle for rear corner sensing for distance and speed are used to sense the speed v1 of the rear vehicle vehᵣₑₐᵣ and the distance D1 between the rear vehicle vehᵣₑₐᵣ and the subject vehicle veh_{subj} as characterizing the driving situation of the rear vehicle vehᵣₑₐᵣ. For this rear corner sensing for distance and speed, radar and lidar are for instance usable. Here it is presumed that L is the length of the subject vehicle veh_{subj} so that the total distance between oncoming vehicle veh_{onc} and the rear vehicle vehᵣₑₐᵣ is the sum of distance D1, length L and distance D2. ADAS sensors of the subject vehicle for forward and/or side sensing lateral localization on the lane are used to sense the distance W of the subject vehicle from the side of the lane, in the example of FIG. 4 from the right side of the lane, as characterizing the driving situation of the subject vehicle veh_{subj}. For this forward and/or side sensing lateral localization on the lane, cameras are for instance usable. Furthermore, the driving situation of the subject vehicle veh_{subj} is further characterized by the speed v_{subj} of the subject vehicle veh_{subj} and the steering angle S of the subject vehicle veh_{subj}. The speed v_{subj} and steering angle S can be obtained for instance via the CAN (Controller Area Network) bus of the subject vehicle veh_{subj}.

The driving situations of the subject vehicle, of the oncoming vehicle and of the rear vehicle as sensed above are then used as follows.

Based on the vehicle speed v1 and the distance D1 of the rear vehicle vehᵣₑₐᵣ and based on the vehicle speed v2 and the distance D2 of the oncoming vehicle veh_{onc}, the time to collision TTC1 between the oncoming vehicle and the rear vehicle is determined.

Subsequently, based on the time to collision TTC1 between the oncoming vehicle and the rear vehicle, the vehicle speed v1 of the rear vehicle and the vehicle speed v2 of the oncoming vehicle the driving distance D of the subject vehicle until the collision point between the oncoming vehicle and the rear vehicle is determined.

In the next step, based on the driving distance D of the subject vehicle and the vehicle speed v_{subj} of the subject vehicle the time to collision TTC2 of the subject vehicle until the collision point between the oncoming vehicle and the rear vehicle is determined, by

$$TTC 2 = \frac{D}{{v}_{subj}} .$$

According to the present disclosure, the thus obtained time to collision TTC2 of the subject vehicle until the collision point between the oncoming vehicle and the rear vehicle is then used to control the subject vehicle for allowing the rear vehicle to overtake the subject vehicle as follows.

In the case that the distance D1 between the rear vehicle and the subject vehicle is 0 or smaller than 0 and the time to collision TTC2 of the subject vehicle is smaller than a first threshold value α, the vehicle speed v_{subj} of the subject vehicle is reduced.

Alternatively thereto or in addition, in the case that the distance D1 between the rear vehicle and the subject vehicle is 0 or smaller than 0 and the time to collision TTC2 of the subject vehicle is smaller than a second threshold value β and the distance W of the subject vehicle from the side of the lane is at least a third threshold γ, the vehicle speed v_{subj} of the subject vehicle is reduced and the subject vehicle is steered towards the side of the lane, as an example a value φ is added to the steering angle S of the subject vehicle. The values α, β, γ and φ are, for instance, specified by the manufacturer of the vehicle and can consider safety standards. They can be obtained for instance via the CAN (Controller Area Network) bus of the subject vehicle veh_{subj}. For the values α, β, the relationship β<α is applicable.

In order to better define the requirements to the ADAS sensors of the subject vehicle it is helpful to consider a worst-case scenario in which the absolute speeds v1 of the rear vehicle, v2 of the oncoming vehicle and v_{subj} of the subject vehicle are about 100 km/h. Moreover, it is presumed that the rear vehicle is next to the subject vehicle. For the ADAS sensors of the subject vehicle for forward sensing for distance and speed, a high detection range sensor is to calculate a sufficient TTC2 range. For instance, with a detection range of 300 m, TTC2 might be 5.4 s based on the above worst-case scenario. In contrast thereto, for rear corner sensing for distance and speed and forward and/or side sensing lateral localization on the lane, there is no need for high-performance sensors.

When allowing a rear vehicle to pass a subject vehicle while avoiding a collision between the subject vehicle and the rear vehicle in a situation of an oncoming vehicle on the lane neighbouring to the lane of the subject vehicle, the following prerequisites are helpful to be considered.

A large amount of data has to be processed since data are shared in the subject vehicle between forward sensors, side sensors and rear sensors. This may be implemented via a centralized architecture.

Furthermore, a common output format for the sensors his helpful, e.g., by a system solution by one supplier. In the case of a centralized architecture, this might already have been fulfilled.

In the present disclosure, the TTC value for two opponents' vehicles are calculated within the subject vehicle instead of receiving information on other vehicles from them. This increases the calculation speed and the reduces the time for the subject vehicle to react on the overtaking manoeuvre of the rear vehicle.

In the drawings, veh_{subj} indicates the subject vehicle, vehᵣₑₐᵣ indicates the rear vehicle, veh_{onc} indicates the oncoming vehicle, v1 indicates the speed of the rear vehicle, D1 indicates the distance between the rear vehicle and the subject vehicle, v2 indicates the speed of the oncoming vehicle, D2 indicates the distance between the oncoming vehicle and the subject vehicle, L indicates the length of the subject vehicle, W indicates the distance of the subject vehicle from the side of the lane, v_{subj} indicates the speed of the subject vehicle, S indicates the steering angle of the subject vehicle, TTC1 indicates the time to collision between the oncoming vehicle and the rear vehicle, D indicates the driving distance of the subject vehicle until the collision point between the oncoming vehicle and the rear vehicle, TTC2 indicates the time to collision of the subject vehicle until the collision point between the oncoming vehicle and the rear vehicle, α, β, γ each indicates the threshold value, and φ indicates the value to be added to the steering angle.

What is claimed is:

1. A method for controlling a subject vehicle when being overtaken by a rear vehicle, the method comprising:
determining driving situations of the subject vehicle, of oncoming traffic in front of the subject vehicle, and of the rear vehicle, in view of overtaking the subject vehicle by the rear vehicle; and
controlling the subject vehicle based on the determined driving situations of the subject vehicle, of the oncoming traffic, and of the rear vehicle, such that in response to determining that the driving situations of the subject vehicle, of the oncoming traffic, and of the rear vehicle, which are currently determined, do not allow a timely overtaking manoeuvre of the subject vehicle by the rear vehicle, a vehicle speed of the subject vehicle is reduced and/or a driving direction of the subject vehicle is changed for allowing the rear vehicle to overtake the subject vehicle.

2. The method for controlling the subject vehicle according to claim 1, wherein
determining the driving situation of the subject vehicle includes determining the vehicle speed of the subject vehicle and/or a position of the subject vehicle in a driving lane in which the subject vehicle is traveling.

3. The method for controlling the subject vehicle according to claim 1, wherein
determining the driving situations of the subject vehicle, of the oncoming traffic in front of the subject vehicle, and of the rear vehicle includes:
determining a vehicle speed of the rear vehicle, a distance between the rear vehicle and the subject vehicle, a vehicle speed of an oncoming vehicle as the oncoming traffic and a distance between the oncoming vehicle and the subject vehicle;
determining a time to collision between the oncoming vehicle and the rear vehicle based on the vehicle speed of the rear vehicle, the distance between the rear vehicle and the subject vehicle, the vehicle speed of the oncoming vehicle, and the distance between the oncoming vehicle and the subject vehicle;
determining a driving distance of the subject vehicle to a collision point between the oncoming vehicle and the rear vehicle based on the time to collision between the oncoming vehicle and the rear vehicle, the vehicle speed of the rear vehicle, and the vehicle speed of the oncoming vehicle; and
determining a time to collision of the subject vehicle to the collision point between the oncoming vehicle and the rear vehicle based on the driving distance of the subject vehicle to the collision point between the oncoming vehicle and the rear vehicle and the vehicle speed of the subject vehicle.

4. The method for controlling the subject vehicle according to claim 3, wherein
controlling the subject vehicle based on the determined driving situations of the subject vehicle, of the oncoming traffic, and of the rear vehicle includes controlling the subject vehicle such that
a) in a case that the distance between the rear vehicle and the subject vehicle is 0 or smaller than 0 and the time to collision of the subject vehicle to the collision point between the oncoming vehicle and the rear vehicle is smaller than a first threshold value, the vehicle speed of the subject vehicle is reduced, and/or
b) in a case that the distance between the rear vehicle and the subject vehicle is 0 or smaller than 0 and the time to collision of the subject vehicle to the collision point between the oncoming vehicle and the rear vehicle is smaller than a second threshold value and a distance of the subject vehicle from a side of the driving lane is equal to or greater than a third threshold, the vehicle speed of the subject vehicle is reduced and the subject vehicle is steered towards the side of the driving lane.

5. The method for controlling the subject vehicle according to claim 4, wherein,
in controlling of the subject vehicle based on the determined driving situations of the subject vehicle, of the oncoming traffic, and of the rear vehicle, a length of the subject vehicle is considered.

6. A vehicle control system for a subject vehicle comprising:
rear sensing means configured to sense a distance between the subject vehicle and a rear vehicle traveling on a rear side relative to the subject vehicle and a vehicle speed of the rear vehicle;
forward sensing means configured to sense a distance between the subject vehicle and an oncoming vehicle traveling in a neighbouring lane to a driving lane of the subject vehicle and a vehicle speed of the oncoming vehicle;
lane sensing means configured to sense a lateral localization of the subject vehicle in the driving lane; and
processing means configured to process (i) the distance between the subject vehicle and the rear vehicle and the vehicle speed of the rear vehicle sensed by the rear sensing means, (ii) the distance between the subject vehicle and the oncoming vehicle and the vehicle speed of the oncoming vehicle sensed by the forward sensing means, and (iii) the lateral localization of the subject vehicle sensed by the lane sensing means for generating output signals for at least one of reducing a vehicle speed of the subject vehicle or steering the subject vehicle to a side of the driving lane of the subject vehicle such that the rear vehicle passes the subject vehicle while avoiding a collision between the subject vehicle and the rear vehicle.

7. The vehicle control system for the subject vehicle according to claim 6, wherein
the processing means is configured to:
determine a time to collision between the oncoming vehicle and the rear vehicle based on the vehicle speed of the rear vehicle, the distance between the subject vehicle and the rear vehicle, the vehicle speed of the oncoming vehicle, and the distance between the subject vehicle and the oncoming vehicle;
determine a driving distance of the subject vehicle to a collision point between the oncoming vehicle and the rear vehicle based on the time to collision between the oncoming vehicle and the rear vehicle, the vehicle speed of the rear vehicle, and the vehicle speed of the oncoming vehicle; and
determine a time to collision of the subject vehicle to the collision point between the oncoming vehicle and the rear vehicle based on the driving distance of the subject vehicle to the collision point and the vehicle speed of the subject vehicle.

8. The vehicle control system for the subject vehicle according to claim 7, wherein
the processing means is configured to generate the output signals such that
a) in a case that the distance between the rear vehicle and the subject vehicle is 0 or smaller than 0 and the time to collision of the subject vehicle to the collision point between the oncoming vehicle and the rear vehicle is smaller than a first threshold value, the vehicle speed of the subject vehicle is reduced, and/or
b) in a case that the distance between the rear vehicle and the subject vehicle is 0 or smaller than 0 and the time to collision of the subject vehicle to the collision point between the oncoming vehicle and the rear vehicle is smaller than a second threshold value and the distance of the subject vehicle from a side of the lane is equal to or greater than a third threshold, the vehicle speed of the subject vehicle is reduced and the subject vehicle is steered towards the side of the lane.

9. The vehicle control system for the subject vehicle according claim 6, wherein
the processing means is configured to consider a length of the subject vehicle.

10. A vehicle control system for a subject vehicle comprising:
a group of sensors configured to: sense a distance between the subject vehicle and a rear vehicle traveling on a rear side relative to the subject vehicle and a vehicle speed of the rear vehicle; a distance between the subject vehicle and an oncoming vehicle traveling in a neighbouring lane to a driving lane of the subject vehicle and a vehicle speed of the oncoming vehicle; and a lateral localization of the subject vehicle in the driving lane; and
a processor, by executing a program stored in a non-transitory storage medium, configured to process (i) the distance between the subject vehicle and the rear vehicle and the vehicle speed of the rear vehicle sensed by the group of sensors, (ii) the distance between the subject vehicle and the oncoming vehicle and the vehicle speed of the oncoming vehicle sensed by the group of sensors, and (iii) the lateral localization of the subject vehicle sensed by the group of sensors for generating an output signal to reduce a vehicle speed of the subject vehicle or steer the subject vehicle to a side of the driving lane of the subject vehicle such that the rear vehicle passes the subject vehicle while avoiding a collision between the subject vehicle and the rear vehicle.
